(19) United States
(12) Patent Application Publication
(10) Pub. No.: US 2007/0161365 A1
(43) Pub. Date: Jul. 12, 2007

(54) Detachable electronic device

(75) Inventor: Chu-Chou Chen, Taipei City (TW)

Correspondence Address: BACON & THOMAS, PLLC, 625 SLATERS LANE, FOURTH FLOOR, ALEXANDRIA, VA, 22314, US

(73) Assignee: D-Link Corporation, Taipei City (TW)

(21) Appl. No.: 11/327,452

(22) Filed: Jan. 9, 2006

(51) Int. Cl. H04B 1/08; H04M 1/00

(52) U.S. Cl. 455/347; 455/575.1

(57) ABSTRACT

The present invention is to provide a detachable electronic device comprising a first housing and a second housing releasbly secured together. Within the first housing there is provided a first circuit board including a first connection member provided at one end of the first circuit board and extended beyond one end of the first housing to connect to an electronic apparatus for communicating current and signal between the first circuit board and the electronic apparatus, and a second connection member provided at the other end of the first circuit board and extended adjacent to the other end of the first housing. Within the second housing there is provided a second circuit board including a third connection member provided at its one end and extended beyond one end of the second housing to connect to the second connection member. Thus, the first and the second housings are assembled together, enabling the first and the second circuit boards to communicate current and signal therebetween.

### FIELD OF THE INVENTION

The present invention relates to portable electronic devices, and more particularly to such a portable electronic device comprising a first housing and a second housing releasbly secured together, enabling both ends of the first housing to connect to an electronic apparatus and the second housing respectively for communicating current and signal therebetween.

### BACKGROUND OF THE INVENTION

This is an information and knowledge explosion era. Communications between people become more frequent. Mobile communication and wireless communication associated with the Internet and communication technology have known a rapid, spectacular development in response to the coming of network era. Also, it quickly expands and is closely associated with our daily life and work. And in turn, it greatly changes the fashion and the way of using electronic devices. For example, wireless local area network (WLAN) is employed as a latest means of communication. WLAN is capable of not only satisfying wireless communication needs of our daily life and work but also providing entertainment and data processing features for satisfying people's needs in such fields. Accordingly, people have more chances to use devices associated with WLAN. This is particularly true for people living in bustling cities. Moreover, more wireless communication products of high performance are commercially available in an even faster pace. Thus, they have become a ubiquitous tool for both personal and work related tasks.

In comparison with the well known wire based local area network (LAN), WLAN has many advantages. For example, the most important advantage thereof is the elimination of the tedious, complicated wiring (i.e., time for waiting technician(s) to come home to wire is saved). A person may operate an electronic device having WLAN feature to connect to the network as long as the electronic device is within a communication range of WLAN. For a user having his or her notebook computer connected to the network, the user may freely move the notebook computer to a desired place for operation without being limited by wires. This feature enables a person to have the network access in home or outdoors. This is why WLAN is gaining popularity among vast consumers. For meeting such needs, a wide variety of multi-functional, wireless communication products of high performance associated with WLAN are commercially available constantly.

For confirming whether the current location of a communication device is within a signal range of WLAN, a prior art WLAN based wireless signal detection device is available from a manufacturer of the art. This wireless signal detection device is disclosed in Taiwanese Utility Model Patent No. M249,366 and is shown in FIG. 1. The detection device comprises a portable body 1 including a wireless signal detection unit 10, a controller 11, and a display and input device 12. The wireless signal detection unit 10 is adapted to receive a wireless signal. The controller 11 is operatively connected to the wireless signal detection unit 10 and is adapted to respond to strength of the wireless signal. The display and input device 12 is operatively connected to the controller 11 and is adapted to convert the response into a display for user viewing by subjecting to a specific procedure. Accordingly, the user may determine whether the wireless signal exists or strength thereof if it exists.

However, both scheme and use concept of the above wireless signal detection device are the same as that of typical electronic devices. Also, the wireless signal detection device has several drawbacks, resulting in a great reduction of convenience and a great limitation in use. For the wireless signal detection device, firstly it has excessive number of components and a complicated construction, and it is expensive. Secondly, it is difficult of downsizing the portable body 1 (i.e., it is bulky) since it has to accommodate the above components. Particularly, display and keypad are provided in the display and input device 12. This is a contrary to the trend of developing slim, compact, and lightweight electronic devices. Further, the wireless signal detection device is only capable of detecting WLAN signals. Thus, a user has to use other network devices to access to the network. As such, the wireless signal detection device is idle when it is not in a detection state. Furthermore, it may bear a great financial burden on users. Thus, it is desirable among vast consumers to provide a slim, compact, lightweight, and multi-functional electronic device having a simple construction and being capable of operating and communicating data in any time in order to overcome the inadequacies of the prior art.

### SUMMARY OF THE INVENTION

After considerable research and experimentation, a detachable electronic device according to the present invention has been devised so as to overcome the above drawbacks (e.g., complicated construction, bulkiness, and idle time) of the prior art wireless signal detection device.

It is an object of the present invention to provide a detachable electronic device comprising a first housing and a second housing releasbly secured together. Within the first housing there is provided a first circuit board including a first connection member provided at one end of the first circuit board and extended beyond one end of the first housing to connect to an electronic apparatus for communicating current and signal between the first circuit board and the electronic apparatus, and a second connection member provided at the other end of the first circuit board and extended adjacent to the other end of the first housing. Within the second housing there is provided a second circuit board including a third connection member provided at its one end and extended beyond one end of the second housing to connect to the second connection member. Thus, the first and the second housings are assembled together. Also, current and signal communication between the first and the second circuit boards is made possible By utilizing this detachable electronic device, it is possible of not only fully employing respective features of the circuit boards but also creating more useful functions by causing the first circuit board to cooperate with the second circuit board, thereby enabling the detachable electronic device to have more applications.

The above and other objects, features and advantages of the present invention will become apparent from the following detailed description taken with the accompanying drawings.

### BRIEF DESCRIPTION OF THE DRAWINGS

FIG. 1 is a block diagram of a conventional wireless signal detection device;

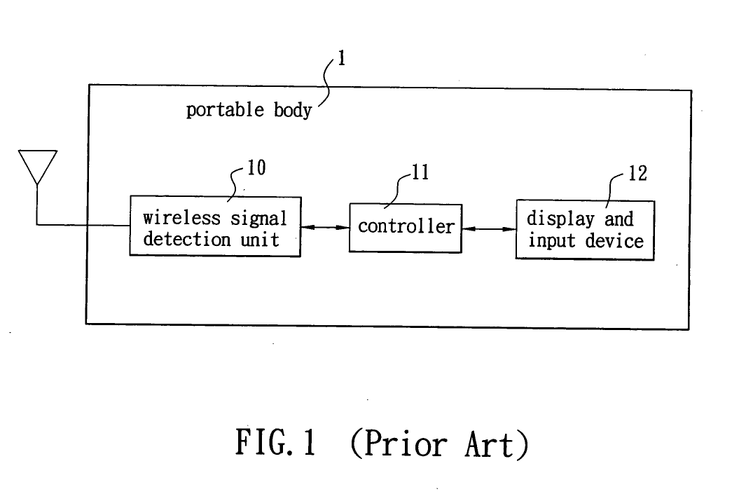

FIG. 2 is a perspective view of a preferred embodiment of detachable electronic device according to the invention.

FIG. 3 is an exploded view of the first housing in FIG. 2;

FIG. 4 is an exploded view of the second housing in FIG. 2;

FIG. 5 is an exploded perspective view illustrating the second housing to be secured to the cap by snapping; and

FIG. 6 is an electric block diagram of the detachable electronic device according to the invention.

### DETAILED DESCRIPTION OF THE PREFERRED EMBODIMENTS

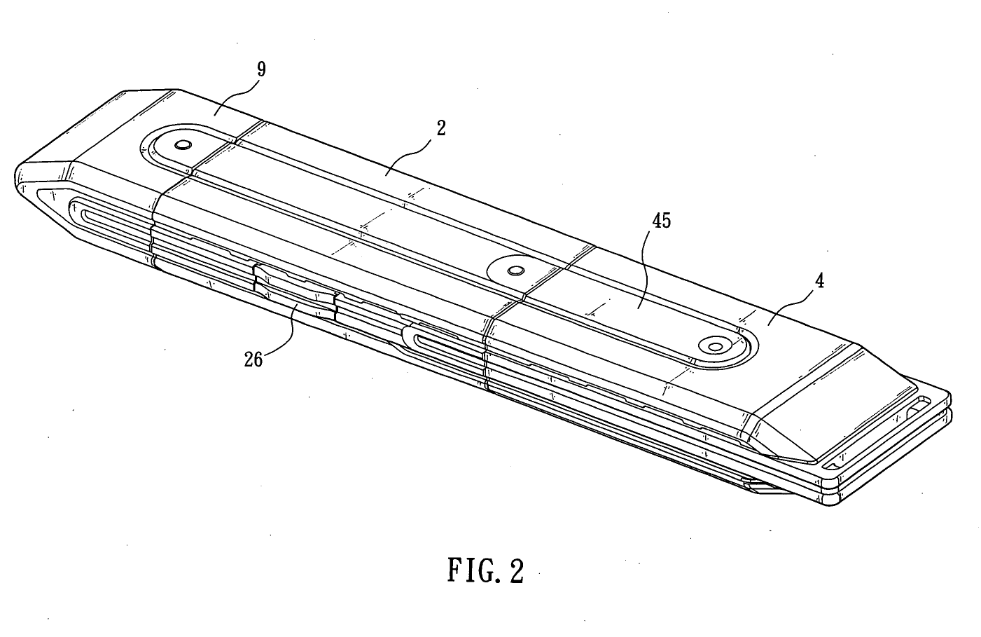

Referring to FIGS. 2 to 4, a detachable electronic device in accordance with a preferred embodiment of the invention comprises a first housing 2 and a second housing 4 releasbly secured together. Within the first housing 2 there is provided a first circuit board 20 including a first connection member 200 and a second connection member 201. The first connection member 200 is provided at one end of the first circuit board 20 and is extended beyond one end of the first housing 2 to connect to an electronic apparatus (e.g., computer). Thus, current and signal communication between the first circuit board 20 and the electronic apparatus is made possible. The second connection member 201 is provided at the other end of the first circuit board 20 and is extended adjacent to the other end of the first housing 2. Within the second housing 4 there is provided a second circuit board 5 including a third connection member 50 provided at its one end and is extended beyond one end of the second housing 4 to connect to the second connection member 201. Thus, the first housing 2 and the second housing 4 are assembled together. Also, current and signal communication between the first circuit board 20 and the second circuit board 5 is made possible.

By configuring the first housing 2 and the second housing 4 as above, it is possible of easily assembling the circuit boards 20 and 5 for carrying out a signal or current communication therebetween. Thus, it is possible of not only fully employing respective features of the circuit boards 20 and 5 but also creating more useful functions by causing the first circuit board 20 to cooperate with the second circuit board 5. Further, convenience in using feature(s) of the detachable electronic device is greatly improved. As a result, the detachable electronic device has more applications and it is capable of operating by itself without the aid of another electronic apparatus.

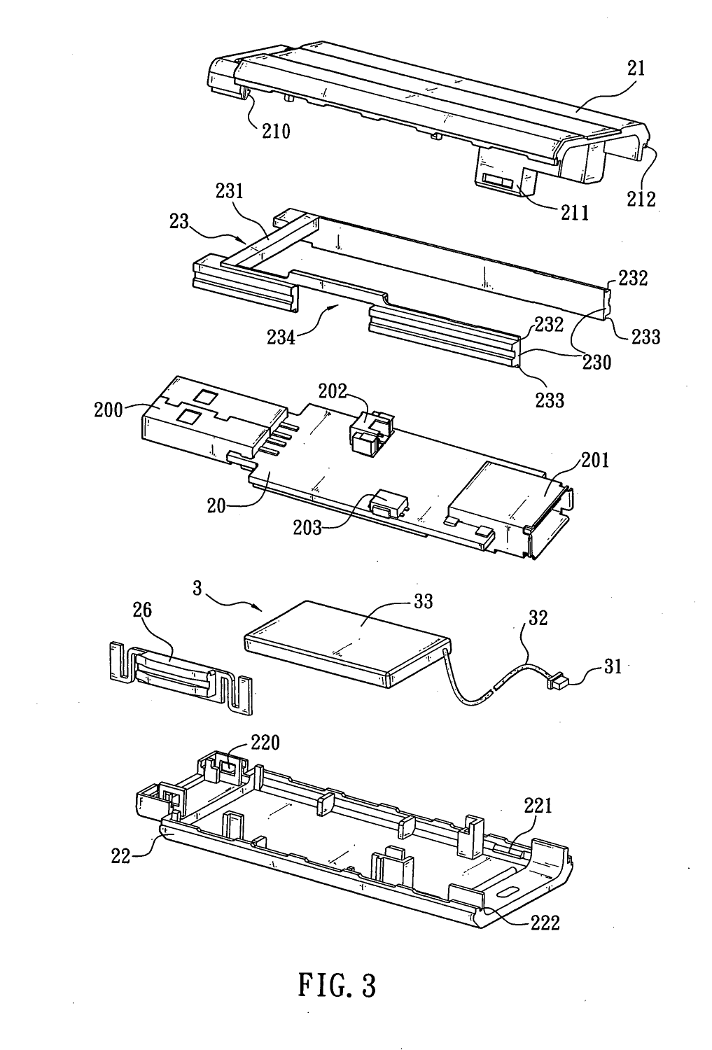

Referring to FIGS. 2 and 3 again, in the embodiment the first housing 2 comprises an upper shell 21, a lower shell 22, and a frame 23. The upper shell 21 is provided on a top of the first circuit board 20. The frame 23 is provided between the upper shell 21 and the first circuit board 20. The lower shell 22 is provided on a bottom of the first circuit board 20 and is secured to the upper shell 21 by snapping. The upper shell 21 is spaced from the lower shell 22 by the frame 23. A front first opening is formed by the assembled upper shell 21 and the lower shell 22 with the first connection member 200 passed the first opening to extend therebeyond. Also, a rear second opening is formed by the assembled upper shell 21 and the lower shell 22 with the second connection member 201 passed the second opening to extend therebeyond to connect to the third connection member 50.

Referring to FIGS. 2 and 3 again, in the embodiment a tab 210 is provided at either side of one end of the upper shell 21 and a hole 220 is provided at either side of one end of the lower shell 22. The tabs 210 are adapted to insert into the holes 220. Likewise, a second tab 211 is provided at either side of the other end of the upper shell 21 and a second hole 221 is provided at either side of the other end of the lower shell 22. The second tabs 210 are adapted to insert into the second holes 220. As an end, a first housing 2 is quickly assembled and secured together by snapping.

Referring to FIGS. 2 and 3 again, in the embodiment the inverted U-shaped frame 23 comprises two side frame elements 230 and a cross rail 231. Either frame element 230 is disposed between one side of the upper shell 21 and the corresponding side of the lower shell 22. One ends of both the side frame elements 230 are extended to one ends of both the upper shell 21 and the lower shell 22. Also, one ends of the side frame elements 230 are formed with both ends of the cross rail 231. Thus, the first opening between one ends (i.e., front ends) of the upper shell 21 and the lower shell 22 is formed and the second opening between the other ends (i.e., rear ends) of the upper shell 21 and the lower shell 22 is formed respectively.

Referring to FIGS. 2 and 3 again, in the embodiment the frame 23 further comprises two pairs of elongate upper flange 232 and elongate lower flange 233. Either upper flange 232 is provided on an outer surface of the side frame element 230 adjacent to the upper shell 21 and is adapted to fit into either elongate side groove 212 of the upper shell 21. Similarly, either lower flange 233 is provided on the outer surface of the side frame element 230 adjacent to the lower shell 22 and is adapted to fit into either elongate side groove 222 of the lower shell 22. As a result, the upper shell 21, the side frame elements 230 (i.e., the frame 23), and the lower shell 22 are secured together.

Referring to FIGS. 2 and 3 again, in the embodiment a resilient member 26 is provided at one side frame element 230. In detail, the resilient member 26 is fitted in an indent 234 of the side frame element 230 for assembling the resilient member 26 and the first housing 2 together. An inner surface of the resilient member 26 facing the first circuit board 20 is adjacent to a switch 203 of the first circuit board 20. Thus, pressing an outer surface of the resilient member 26 (i.e., opposite the indent 234) will turn on the switch 203. As a result, a number of functions of the first circuit board 20 and the second circuit board 5 can be activated. By configuring the resilient member 26 as means for turning on the switch 203 of the first circuit board 20 and the second circuit board 5, it is possible of decreasing space for accommodating an additional switch. As an end, size is decreased and a slim, compact, lightweight, and aesthetic detachable electronic device is obtained.

Referring to FIGS. 2 and 3 again, in the embodiment a power source 3 is provided between the first circuit board 20 and the lower shell 22. The power source 3 comprises a plug 31, a power cord 32, and a rechargeable battery 33. The plug 31 is adapted to insert into a socket 202 provided on the first circuit board 20. The other open end of the power cord 32 is terminated at the plug 31 and one end thereof is electrically connected to the rechargeable battery 33. Power is supplied to the rechargeable battery 33 for charging through the plug 31 and the power cord 32 when power is supplied from the activating electronic device to the first circuit board 20. In response to turning on the switch 203 by the resilient member 26, the rechargeable battery 33 is adapted to supply current to the first circuit board 20 through the power cord 32 and the plug 31. The current is then supplied from the first circuit board 20 to the second circuit board 5. By configuring as above, it is possible of supplying power to both the first circuit board 20 and the second circuit board 5 for activating same at the same time.

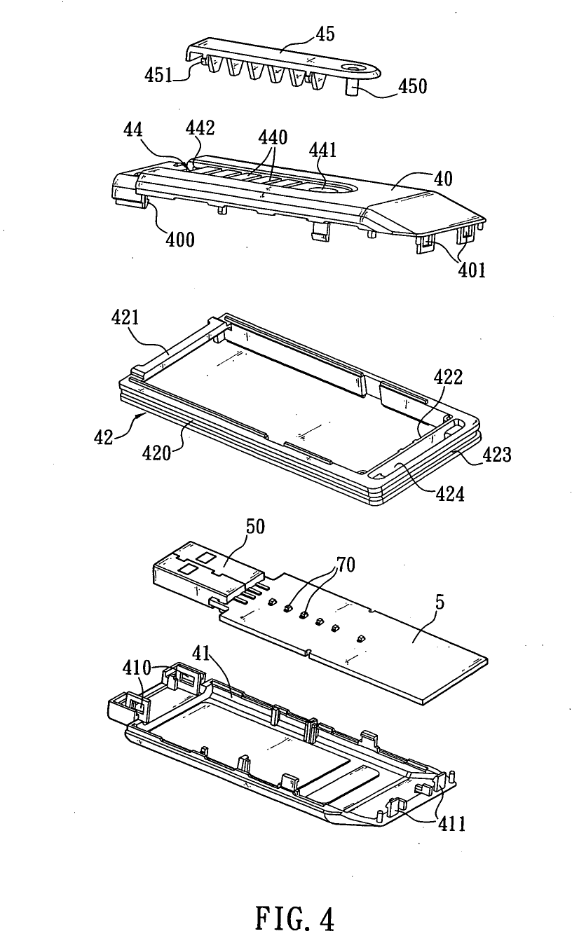

Referring to FIGS. 2 and 4 again, in the embodiment the second housing 4 comprises an upper shell 40, a lower shell 41, and a rectangular, hollow frame 42. The upper shell 40 is provided on a top of the second circuit board 5. The frame 42 is provided between the upper shell 40 and the second circuit board 5. The lower shell 41 is provided on a bottom of the second circuit board 5 and is adapted to secure to the upper shell 40 by snapping. The upper shell 40 is spaced from the lower shell 41 by the frame 42. A front third opening is formed by the assembled upper shell 40 and the lower shell 41 with the third connection member 50 passed the third opening to extend beyond the second housing 4 to connect to the second connection member 201. Thus, current and signal communication between the first circuit board 20 and the second circuit board 5 is made possible.

Referring to FIGS. 2 and 4 again, in the embodiment a first tab 410 is provided at either side of one end of the upper shell 40 and a first hole 410 is provided at either side of one end of the lower shell 41. The first tabs 410 are adapted to insert into the first holes 410. Likewise, two spaced second holes 401 are provided at the other end of the upper shell 40 and two spaced second tabs 411 are provided at the other end of the lower shell 41. The second tabs 411 are adapted to insert into the second holes 401. As an end, a second housing 4 is quickly assembled and secured together by snapping.

Referring to FIGS. 2 and 4 again, in the embodiment the frame 42 comprises two side frame elements 420, a front first cross rail 421, a rear frame element 423, and a second cross rail 422 adjacent to the rear frame element 423. Either side frame element 420 is disposed between one side of the upper shell 40 and the corresponding side of the lower shell 41. One ends of the side frame elements 420 are formed with both ends of the first cross rail 421 adjacent to the third opening. Both ends of the second cross rail 422 are formed with rear portions of the side frame elements 420 adjacent to the other ends of the side frame elements 420 and the other ends of the upper shell 40 and the lower shell 41. Both ends of the rear frame element 423 are formed with the other ends of the side frame elements 420. A slit 424 is thus formed between the rear frame element 423 and the second cross rail 422. A lanyard or the like may pass the slit 424 to form a loop which is adapted to put on, for example, either the neck of a user or a suitable object so as to hang the detachable electronic device.

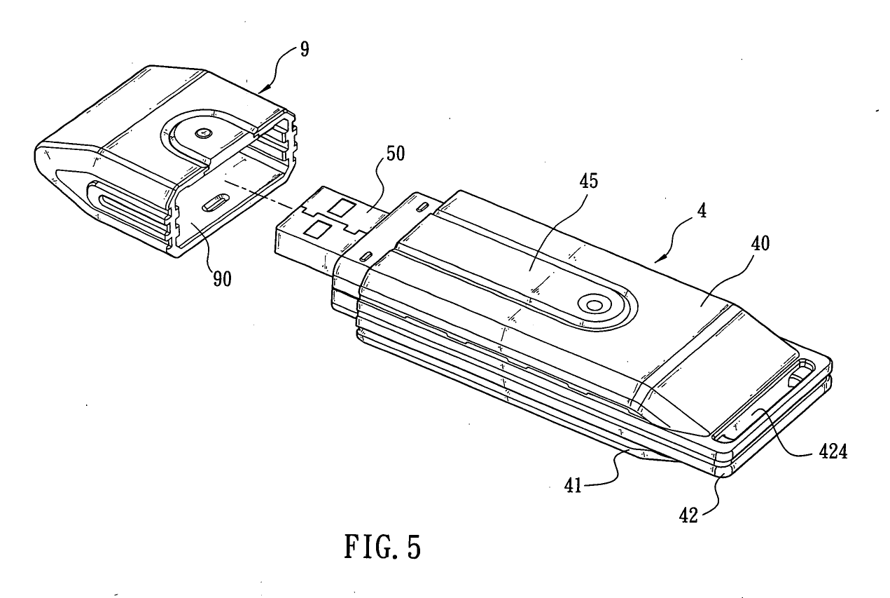

Referring to FIG. 5 in conjunction with FIG. 2, in the embodiment the first connection member 200 is adapted to secure to a cap 9 when the first connection member 200 is not engaged with the electronic device. The third connection member 50 is also adapted to secure to the cap 9 when the third connection member 50 is engaged with the second connection member 201. The cap 9 comprises an internal space 90 extended from one closed end to the other open end. Either the first connection member 200 or the third connection member 50 is adapted to insert into the space 90 through the other open end of the cap 9 and is thus protected. As an end, the detachable electronic device is well protected when it is carried by a user.

Referring to FIGS. 2 and 4 again, in the embodiment a display area 44 is recessed on a top surface of the upper shell 40. One end of the display area 44 is terminated at one end of the upper shell 40 and the other end thereof is extended to the other end of the upper shell 40 adjacent to the third opening. Within the display area 44 there are provided a plurality of parallel projections 440 extended from one end of the display area 44 to the other end thereof. A number of items representing the operating status of the second circuit board 5 are shown on the display area 44 when the second circuit board 5 is activated.

Referring to FIGS. 2 and 4 again, in the embodiment a cover 45 is formed above the display area 44 and is adapted to snugly fit onto the display area 44. A peg 450 adjacent to the other end of the cover 45 is extended downward from a bottom thereof. The peg 450 is adapted to snugly insert into a hole 441 adjacent to the other end of the display area 44. Two bottom latches 451 are formed at both sides of the cover 45 adjacent to its one end. The latches 451 are adapted to insert into two side troughs 442 of the display area 44 adjacent to its one end. As an end, the cover 45 is secured to a top of the display area 44.

Referring to FIGS. 3 and 4 again, in the embodiment the first connection member 200 is implemented as a USB (Universal Serial Bus) connector, the second connection member 201 is implemented as a USB port, and the third connection member 50 is implemented as a USB connector. By configuring the first connection member 200, the second connection member 201, and the third connection member 50 as above, the first connection member 200 is adapted to receive electric power from the electronic device when the first connection member 200 is inserted into a port (e.g., a USB port) of the electronic device. The received electric power is supplied to the power source 3 or the second circuit board 5. As a result, a signal communication between the electronic device and the first circuit board 20 and a signal communication between the electronic device and the second circuit board 5 are made possible.

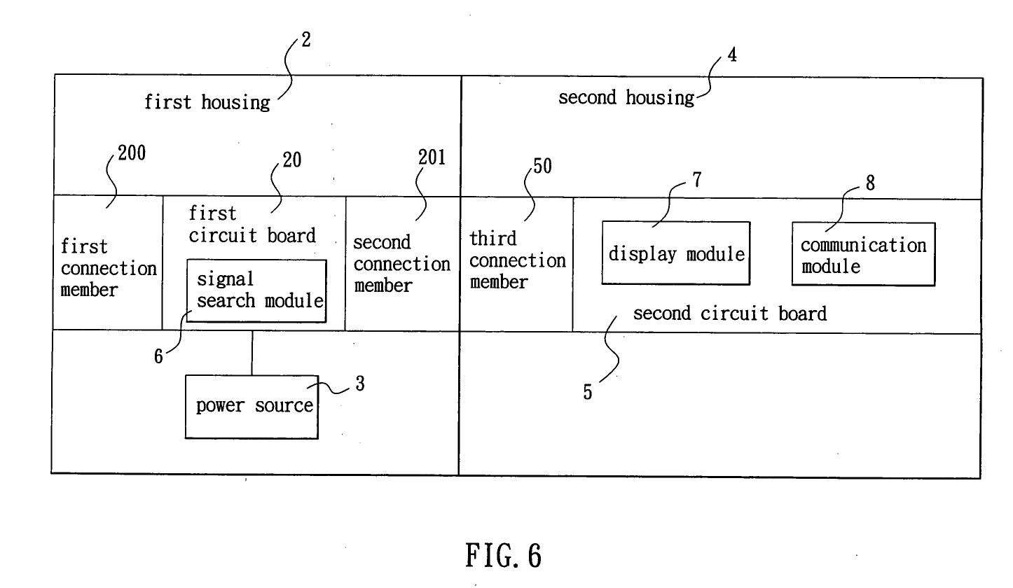

Referring to FIG. 6 in conjunction with FIG. 2, in the embodiment a signal search module 6 is further provided on the first circuit board 20. The signal search module 6 is enabled when external power or electric current stored in the rechargeable battery 33 is supplied to the first circuit board 20. The signal search module 6 is adapted to receive a WLAN signal, detect strength of the WLAN signal, and generate a detection signal in response thereto. The detection signal is then sent to the second circuit board 5 via the second connection member 201 and the third connection member 50.

Referring to FIGS. 3 and 6 again, in the embodiment the second circuit board 5 further comprises a display module 7 and a communication module 8. The display module 7 is adapted to receive the detection signal and display a plurality of different items representing the operating status on the display area 44. The communication module 8 is adapted to receive a signal sent from the electronic device for communicating with WLAN. The electronic device is adapted to detect strength of the WLAN signal and communicating signal with WLAN by means of the modules 6, 7, and 8.

Referring to FIGS. 4 and 6 again, in the embodiment the display module 7 comprises a plurality of light emitting members 70. The display module 7 is adapted to provide a corresponding amount of electric power to each of the light emitting members 70 in response to the received detection signal. A user is thus visually informed of the strength of the wireless signal being received as the number of the lit light emitting members 70 is changed.

Referring to FIGS. 3, 4, and 6 again, in the embodiment each of the light emitting members 70 is implemented as an LED (light emitting diode). The light emitting members 70 are spaced and are disposed in a straight line from a center of the second circuit board 5 to be adjacent to one end of the third connection member 50. Each of the light emitting members 70 corresponds to a projection 440. The light emitting members 70 are adapted to emit light to the cover 40 as being enabled by the input electric power. As a result, an indication similar to bar chart is displayed on the cover 40 for indicating the operating status of the electronic device.

The first housing 2 and the second housing 4 are fitted together as contemplated by the invention, resulting in an easy connection of the circuit boards 20 and 5. Also, each of the connection members 200, 201, and 50 is implemented as a USB connector or port. Thus, not only signal or current communication is made possible but also both the circuit boards 20 and 5 are readily adapted to electrically connect together due to the plug-and-play characteristic of USB standard. As a result, a number of functionalities including data transfer, signal receiving, signal transmission, AV playing, network access, and power communication are enabled. As an end, it is possible of not only fully employing respective features of the circuit boards 20 and 5 but also creating more useful functions by causing the first circuit board 20 to cooperate with the second circuit board 5 with convenience in using feature(s) of the electronic device being greatly improved.

While the above embodiment of the invention discussing details of searching WLAN signals and cooperation for accessing to the network is only a preferred embodiment thereof, it is apparent that a detachable electronic device of the invention is not limited to such in practice. For example, it is possible of improving quality and strength of received wireless signal by connecting a wireless signal search network card and an antenna module together. Alternatively, it is possible of configuring the detachable electronic device as a portable hard disk drive for network access by connecting a wireless signal search network card and a flash disk together. Still alternatively, it is possible of configuring the detachable electronic device as a portable wireless network music player by connecting a wireless signal search network card and a network music player together. By configuring the detachable electronic device as above, it is possible of bringing more convenience to users while enjoying a variety of functions provided by the electronic device.

In view of the above, components of the invention have the following benefits:

i) The detachable electronic device can have more applications by causing the first circuit board 20 to cooperate with the second circuit board 5 or employing respective features of the circuit boards 20 and 5. Further, the applications are flexible depending on needs.

ii) A number of items representing the operating status of the electronic device are shown on the display area 44, resulting in an elimination of space occupation of mounting a display on a well known electronic device, a reduction of the components, a reduction of the manufacturing cost, and a reduction of the size of the detachable electronic device.

iii) By configuring the resilient member 26 at one side of the first housing 2 as means for turning on the switch, it is possible of decreasing space for accommodating an additional switch and preventing a user from triggering the switch by mistake.

iv) The power source 3 is adapted to supply electric current to both the first circuit board 20 and the second circuit board 5 when the detachable electronic device is not electrically connected to another electronic apparatus. Thus, both the first circuit board 20 and the second circuit board 5 are adapted to operate normally and the detachable electronic device is adapted to activate without the aid of another electronic apparatus.

v) Each of the light emitting members 70 corresponds to a projection 440. Thus, the light emitting members 70 are adapted to illuminate the display area 44. As a result, an indication for showing the operating status of the second circuit board 5 is displayed on the display area 44.

While the invention herein disclosed has been described by means of specific embodiments, numerous modifications and variations could be made thereto by those skilled in the art without departing from the scope and spirit of the invention set forth in the claims.

What is claimed is:

1. A detachable electronic device comprising:
a first housing including an internal first circuit board including a first connection member provided at one end of the first circuit board, the first connection member being extended beyond one end of the first housing to connect to an electronic apparatus for communicating a current and a signal therebetween, and a second connection member provided at the other end of the first circuit board, the second connection member being extended adjacent to the other end of the first housing; and
a second housing including an internal second circuit board including a third connection member provided at its one end, the third connection member being extended beyond one end of the second housing to connect to the second connection member, thereby assembling the first and the second housing together and communicating a current between the first and the second circuit boards.

2. The detachable electronic device of claim 1, wherein the first housing comprises:
an upper first shell provided on a top of the first circuit board;
a first frame provided between the upper first shell and the first circuit board; and
a lower first shell provided on a bottom of the first circuit board and secured to the upper first shell;
wherein the upper first shell is spaced from the lower first shell by the first frame, a front first opening is formed by the upper and the lower first shells with the first connection member passed the first opening to extend therebeyond, and a rear second opening is formed by the upper and the lower first shells with the second connection member passed the second opening to extend therebeyond to connect to the third connection member.

3. The detachable electronic device of claim 2, further comprising a first tab formed at either side of one end of the upper first shell, a first hole formed at either side of one end of the lower first shell, the first tabs being adapted to insert into the first holes, a second tab formed at either side of the other end of the upper first shell, and a second hole formed at either side of the other end of the lower first shell, the second tabs being adapted to insert into the second holes.

4. The detachable electronic device of claim 2, wherein the first frame is shaped as a U and comprises:
two side frame elements either disposed between one side of the upper first shell and the corresponding side of the lower first shell, and one ends of both the side frame elements being extended to one ends of both the upper and the lower first shells; and
a first cross rail having both ends formed with one ends of the side frame elements.

5. The detachable electronic device of claim 4, wherein the first frame further comprises:
two elongate upper flanges either provided on an outer surface of the side frame element adjacent to the upper first shell and being adapted to fit into either elongate side groove of the upper first shell; and
two elongate lower flanges either provided on the outer surface of the side frame element adjacent to the lower first shell and being adapted to fit into either elongate side groove of the lower first shell.

6. The detachable electronic device of claim 4, further comprising a resilient member provided at a predetermined position between two ends of one side frame element, the resilient member being fitted in a recessed portion of the side frame element, and a switch provided on the first circuit board, wherein an inner surface of the resilient member facing the first circuit board is adjacent to the switch such that pressing an outer surface of the resilient member opposite the indent will turn on the switch.

7. The detachable electronic device of claim 6, further comprising a power source provided between the first circuit board and the lower first shell, the power source including:
a plug being adapted to insert into a socket provided on the first circuit board;
a power cord having the other open end terminated at the plug; and
a rechargeable battery electrically connected to one end of the power cord;
wherein power is supplied from the activating electronic apparatus to the first circuit board through the plug and the power cord for charging the rechargeable battery, and in response to turning on the switch by the resilient member, the rechargeable battery is adapted to supply a current to the second circuit board through the power cord, the plug, and the first circuit board.

8. The detachable electronic device of claim 2, wherein the second housing comprises:
an upper second shell provided on a top of the second circuit board;
a second frame provided between the upper second shell and the second circuit board; and
a lower second shell provided on a bottom of the second circuit board and adapted to secure to the upper second shell;
wherein the upper second shell is spaced from the lower second shell by the second frame, a front third opening is formed by the upper and the lower second shells with the third connection member passed the third opening to extend beyond the second housing, and the other end of the second frame is extended beyond the rear other ends of the upper and the lower second shells.

9. The detachable electronic device of claim 8, further comprising a third tab formed at either side of one end of the upper second shell, a third hole formed at either side of one end of the lower second shell, the third tabs being adapted to insert into the third holes, two spaced fourth holes formed at the other end of the upper second shell, and two spaced fourth tabs formed at the other end of the lower second shell, the fourth tabs being adapted to insert into the fourth holes.

10. The detachable electronic device of claim 8, wherein the second frame is a hollow rectangle and comprises:
two side frame members either disposed between one side of the upper second shell and the corresponding side of the lower second shell;
a front second cross rail having both ends formed with one ends of the side frame members adjacent to the third opening;
a rear third cross rail having both ends formed with rear portions of the side frame members adjacent to the other ends thereof and the other ends of the upper and the lower second shells; and
a rear frame member having both ends formed with the other ends of the side frame members for forming a slit between the third cross rail and itself.

11. The detachable electronic device of claim 8, further comprising a cap having an internal space open to the other end thereof, wherein the first connection member is adapted to secure to the cap by inserting into the space.

12. The detachable electronic device of claim 11, wherein the third connection member is adapted to secure to the cap by inserting into the space.

13. The detachable electronic device of claim 8, further comprising a recessed display area formed on a top surface of the upper second shell, the display area having one end terminated at one end of the upper second shell and the other end extended to the other end of the upper second shell adjacent to the third opening.

14. The detachable electronic device of claim 13, wherein the display area comprises a plurality of projections extended from one end to the other end.

15. The detachable electronic device of claim 14, further comprising a cover formed above the display area and adapted to fit onto the display area.

16. The detachable electronic device of claim 15, wherein the display area comprises an aperture adjacent to the other end, and two side troughs one end; and the cover includes a bottom peg adjacent to the other end, the peg being adapted to securely insert into the aperture, and two side bottom latches adjacent to one end, the latches being adapted to insert into the troughs.

17. The detachable electronic device of claim 14, wherein the first circuit board further comprises a signal search module, the signal search module being adapted to receive a WLAN (wireless local area network) signal, detect strength of the WLAN signal, and generate a detection signal in response thereto.

18. The detachable electronic device of claim 17, wherein the second circuit board further comprises:
a display module adapted to receive the detection signal and display a plurality of different items representing an operating status of the detachable electronic apparatus on the display area; and
a communication module adapted to receive a signal sent from the electronic apparatus for communicating with a WLAN.

19. The detachable electronic device of claim 18, wherein the display module comprises a plurality of light emitting members, the display module being adapted to provide a corresponding amount of electric power to each of the light emitting members in response to the received detection signal.

20. The detachable electronic device of claim 19, wherein each of the light emitting members is an LED (light emitting diode), the light emitting members are spaced and are disposed in a straight line from a center of the second circuit board to be adjacent to one end of the third connection member, and each of the light emitting members corresponds to one of the projections.
